(19) United States
(12) Patent Application Publication
(10) Pub. No.: US 2023/0245636 A1
(43) Pub. Date: Aug. 3, 2023

(54) DEVICE, SYSTEM AND METHOD FOR PROVIDING AUXILIARY INFORMATION TO DISPLAYED MUSICAL NOTATIONS

(71) Applicant: Joytunes Ltd., Kfar Saba (IL)

(72) Inventors: Amitay Dobo, Kfar Saba (IL); Yoav Biderman, Kfar Saba (IL); Bar Almakayes, Kfar Saba (IL); Eran Aharonson, Kfar Saba (IL); Oded Essner, Kfar Saba (IL); Almog Segalis, Kfar Saba (IL)

(21) Appl. No.: 18/161,039

(22) Filed: Jan. 28, 2023

Related U.S. Application Data
(60) Provisional application No. 63/305,818, filed on Feb. 2, 2022.

(51) Int. Cl. G10H 1/00; G09B 15/00

(52) U.S. Cl. CPC G10H 1/0016; G09B 15/003; G10H 1/0025

(57) ABSTRACT

A method and system for indicating musical notations for at least one user to execute, including: presenting the at least one user with musical notations on a presentation device, the musical notation to be executed through the user; receiving an audio signal relating to an instrument played and/or vocal output generated by the at least one user; analyzing the received audio signal to obtain an analysis output; and selecting a section of the musical notation, wherein the section contains a musical note coinciding with the received audio signal and which is descriptive of a temporal interval having a longer duration than the coinciding note played through the user.

### CROSS-REFERENCE TO RELATED APPLICATIONS

This application claims the benefit of priority from U.S. provisional patent application No. 63/305,818 filed Feb. 2, 2022, which is incorporated herein by reference in its entirety.

### TECHNICAL FIELD

The present disclosure relates to a method and system for presenting a user with musical notations on a digital medium and, more specifically, to a method and system for guiding a user through the musical notations based on the user's own playing of the musical notations.

### BACKGROUND

When people play music, especially when learning to play an instrument, the student or musician uses printed sheet music or digital sheet music. Digital sheet music (i.e., musical notations displayed on or by a digital/computerized medium) usually has a scrolling and note following function where the scrolling is either done manually or the music is scrolled at a constant speed (metronome-based). Both of these options have drawbacks. The musician does not always have printed sheet music when they want to play a specific piece. On the other hand, with digital sheet music, it is cumbersome to perform manual scrolling while playing and, especially for a learner, it may be difficult or counter-productive to follow a predetermined pace. In many cases, the method used to learn a piece of music is to repeat a certain part over and over and then continue; or sometimes to jump back and/or forward to skip a hard part and continue the playing.

### BRIEF DESCRIPTION OF THE DRAWINGS

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The number of elements shown in the Figures should by no means be construed as limiting and is for illustrative purposes only. The figures are listed below.

FIG. 1 is a depiction of a user learning to play guitar.

FIG. 2A is a flowchart of steps in a method for following music being played by the user, including highlighting the area of the notes being/to be played and scrolling the pages, all in a smoothly flowing manner.

FIG. 2B is a schematic depiction of musical notation containing such highlighted section, highlighted by an indicator.

FIG. 3 is a flowchart of additional steps in the process of predicting the subsequent notes to be played.

FIG. 4 is a diagram depicting components related to selection and setting of the I/O devices.

### DETAILED DESCRIPTION

Aspects of the present invention pertain to a computerized device, system and method for visually presenting musical notations to a user that will be executed through or by the user by playing an instrument and/or singing. Visually presenting the notations is accomplished using a computerized application executed by the computerized device of the system. The expression “musical notation” as used herein may include, for example, notes, tabs, and/or lyrics.

Existing systems and methods provide an application executed by a computing platform or computing device such as a mobile phone, smart phone, tablet, a laptop, a desktop computer, augmented reality displays, virtual reality displays, and/or the like. The application enables a user to choose a piece of music and playing level from a selection of musical pieces and playing levels.

Background music (BGM) (also: audio playback) provided by the application may then be played through one or more speakers associated with the device or external thereto, and the user can play and/or sing along with the BGM, which provides the user with an improved music experience.

Audio signals generated by the user through playing an instrument and/or singing may herein also be referred to as “user-generated audio signal”. The user-generated audio signal combined with, for example, the BGM, audio signals generated by other users playing instruments and/or signing, and/or environment noises, may herein be referred to as “composite audio signals”.

The expression “generating an audio signal” and grammatical variations thereof may encompass producing an audio signal output that is generated through/by playing an electronic instrument, referring to the output by the electronic instrument, as well as audio signals generated through picking up, by at least one microphone, acoustic waves produced when playing an instrument and/or singing musical notes presented to the user.

The user may also be provided with presented notes, tabs, lyrics and/or other musical notations displayed on or by a display device such as a display associated with the computing platform. It is noted that the expressions “audio signal” and “sound”, as used herein, may for example refer to electronic signals generated based on acoustic wave energy produced when playing an instrument and/or singing and/or electronic signals provided by through electronic signal outputs of electronic instruments.

Currently available devices such as but not limited to smartphones, comprise a plurality of I/O devices, such as one or more microphones and one or more speakers. Some devices may comprise three microphones, located for example on the bottom, upper front, and/or upper back of the device, and three speakers, one on the top and two at the bottom of the device. The plurality of I/O devices are generally required for the various operation modes and algorithms executed by the device, such as handset or speaker modes, video capture, noise reduction, echo cancellation, keyword triggering, or the like.

A typical scenario in music playing, teaching and/or practicing application in accordance with the disclosure may be described as follows: a user may select an instrument to play, such as a guitar or a piano and a piece to play. BGM may be played or may not be played to accompany the user.

The instant system provides a smart guide which is configured to track the user's progress through the digital music sheet and/or predict the next notes, tabs and/or lyrics, the user will play and/or sing without the user needing to take their hands off the musical instrument (e.g., to scroll backwards or forwards to the desired position). Further, the system tracks the user's progress through the notes, regardless of the user's playing ability, tempo, repetitions and/or jumps.

The instant system employs algorithms (e.g., machine learning (ML), matching algorithms, search algorithms) to assess or determine an estimate relating to the specific user's progress, for instance, to determine whether the progress is linear or nonlinear. The system may learn what to expect from the user by learning from the user's past behavior, recognizing what is being played, and/or comparing that to the expected music notes. The idea is to “read” the user's mind and progress with the score (also referred to herein as “digital sheet music”, “music notes”, “musical notations” and variations thereof) according to the user's playing of the score and/or as the system expects/predicts the user to progress.

The user is intending to play with a certain flowing-ness and expects a graphical indicator to move in (about) the same way (e.g., direction and/or speed), in accordance with the user's execution or playing of the musical notations presented to him/her. In order to display or indicate the user's “current” position/location on the digital sheets (i.e., which musical notes correspond to the music being played—hereafter also referred to as “staff notation position”), it is important to understand the flow of the user's playing, i.e., to “intuitively” predict how and, optionally, subsequent notes the user is going to play. The system then uses this knowledge to indicate on the display the area that the user is playing and/or going to play next. The system does this in a manner such that the user perceives the change in position of the indicator in a flowing and/or continuous manner, and without delay (hereafter also referred to as a “smooth flow”). In some embodiments, the indicator's smooth flow reflects a Real-Time tracking of the user's music through displayed musical notes. This feature is in contrast to legacy systems in which a displayed cursor and/or highlighted note is displayed for a specific note being played by the user, which may result in the highlighting of musical notations at a comparatively erratic, delayed and/or intermittent manner.

It is noted that the terms “indicator” and “indication” may herein be used interchangeably.

“Real-time” as used herein generally refers to the updating of information at essentially the same rate as the data is received. For example, in the context of the present invention “real-time” is intended to mean that the sound or audio signals generated through the playing of an instrument by a user, are acquired and processed for presenting the user with related information at a high enough data rate and at a low enough time delay that when the information is displayed, objects are visualized without user-noticeable judder, latency or lag.

In some embodiments, prediction may be used to help the system anticipate which notes will be played next, thereby helping to shave off even more time between input and display.

The term “area” as used herein may refer to a section or a part of staff notation displayed to the user by the system. In some embodiments, the section may encompass or have a duration that is longer than one beat and include, for example, at least two beats of the musical piece.

In some embodiments, the user may be presented, concurrently, with a plurality of different musical indicators. For example, a first indicator of the plurality of indicators may highlight a section of longer duration, and a second indicator of the plurality of indicators may highlight a section of shorter duration than the first indicator. In some examples, the second indicator may be displayed in overlap with the first indicator. For instance, the first indicator may highlight a certain staff (also: stave), and the second indicator may highlight a section of the highlighted stave.

In some embodiments, a musical notation section containing one or more notes played by the user a second time (e.g., to correct for an error) may be highlighted differently than a musical notation section displayed to the user for playing in the chronological order.

In some embodiments, a first indicator may pertain to notes to be played and/or being played by the user's right hand, and a second indicator may pertain to notes to be played and/or which are being played by the user's left hand. In some examples, the first indicator and the second indicator may be positionally shifted relative to each other with respect to each other to indicate a temporal shift with respect to the musical notation being played by the user. In some examples, the first and the second indicator may be displayed in positional alignment relative to each other with respect to the musical notations to be played by the user.

Some of the difficulties in accurately presenting the current position in the score include, for example:

1. Inherent delay in recognition/note capturing;

2. Recognition errors;

3. How to achieve a flowing pace and prevent erratic movement of the indicator;

4. Synchronizing the algorithm's prediction with the user's performance; especially when it comes to the pace (BPM) of the playing; and/or

5. How to display the indicator for maximum effectiveness and to provide the most support to the user in his/her playing and/or singing. For example, characteristics of the indicator may depend on, or be selected (e.g., optimized) based on the type of instrument being played, pace or tempo, a musical section is being played and/or being sung, the musical style, whether the user is playing with or without BGM, with or without other players, a determined or selected skill level estimation of the user; difficulty of the musical piece or exercise to be executed through the user, whether the user is playing notes of a repetitive exercise; display modality (e.g., tablet, virtual reality, augmented reality) or playing a musical composition, and/or the like. Indicator characteristics may include duration, display modality (e.g., underline and/or font style of the notes of the highlighted section), display occurrence (e.g., continuous highlighting or selectively highlighting/not highlighting sections of the musical piece/exercise), and/or the like.

In an effort to address at least one of the above-noted issues, the instant system displays the indicator in the form of a highlighted area (hereafter also referred to as the “cloud”). The system highlights, for example, a potential area where the next note is predicted to be played. In some examples, areas of notes already played and/or notes to be played next may also be highlighted. This way, the user's brain can detect the position without an explicit “cursor” positioned at a particular note. The highlighted playing area or region allows the depicted flow of the playing to be smoother.

The terms playing “area” and “region” are used interchangeably with regard to the cloud indicator. A region/area refers to consecutive notes on the sheet. In one example embodiment the highlighted area includes only the note being played and/or notes that have been played (past and/or present notes). In another example embodiment, the highlighted area includes past, present and future notes. In yet another example embodiment the highlighted notes include only present and future notes. In yet another example embodiment, the highlighted notes include only future notes.

When the present and predicted future notes are not consecutive, then the currently highlighted area and the future highlighted area are referred to as “locations” or “positions”. In embodiments, an area in a first location may be highlighted and subsequently another area in a second, non-consecutive location may be highlighted. In some embodiments a path between the first and second location may be graphically indicated between highlighting the first location and highlighting the second location. The aforementioned notwithstanding, it is also acceptable terminology to describe the position as changing when region encompassed by the highlighting changes to indicate sequential notes (be it forwards or backward (e.g., repeating one or two notes), i.e., when the region or cloud indicator ‘moves’ forwards or backwards.

It is made clear that the highlighting (and hence the special meaning of the term “highlighting” within the instant document) can be any form of emphasizing of an area or region where the notes are displayed. For example, the notes themselves, the space below and/or the space above the notes may be colored, made bold, underlined, underscored, accented, and/or increased in prominence in any manner that can be visually presented on the device display. Highlighting the area or region of the notes that the user is playing and/or will play next also, or alternatively, includes any manner of drawing attention to that area by visually manipulating the depicted image and/or the display device itself (e.g., changing brightness, contrast and/or color saturation and the like). In some embodiments, the system may be configured to allow the user to select one or more forms of highlighting such as underlining notes and presenting the same notes of the highlighted area in bold, etc. In some examples, the indicator, which may highlight a section of an entire musical notation sequence, may represent a constant duration (representation of a time period), a dynamic duration, or an adaptive duration. A static duration indicator represents a predetermined time interval length that remains constant. A dynamic temporal length indicator represented a time interval that may be forcefully changed, for example, throughout a certain music piece (e.g., each bar), and an adaptive duration indicator may change based on or in response to changes in characteristics of audio data generated by the user and processed by the system.

Additionally, or alternatively, the time interval represented by the indicator may depend, for example, on the tempo of a selected musical piece displayed to the user for playing thereby. For example, a time interval indication may be longer for a musical piece that is to be played at a first, greater speed or tempo (beats per minute), than the time interval indication displayed for a musical piece to be played at a second, comparatively slower tempo. For example, a time interval indication may be shorter for a musical piece that is to be played at a first, greater speed or tempo (beats per minute), than the time interval indication displayed for a musical piece to be played at a second, comparatively slower tempo.

In some examples, a “longer” time interval indication may be longer compared to a “shorter” time interval indication in terms of beats per minute of a musical piece. In some examples, a “longer” time interval indication may be longer in absolute terms compared to a “shorter” time interval indication, irrespective of the tempo of the musical piece displayed to the user.

In some embodiments, the system may be configured to select to what extent the indicator is to be displayed (e.g., continuously or only partially). Thus, the system may be configured such that the indicator may be selectively displayed or not display the indicator, for example, to train the user or player in reading musical notations. In some examples, the number of times the indicator is displayed during the display of musical notations of a musical piece (e.g., composition, exercise, etc.) may change, for example, based on a user's skill level estimate determined by the system. In some examples, the number of times the indicator is displayed may change, for example, based on user-provided preferences.

The instant system and method can be combined with previous inventions by the same inventor pertaining to auto change of the user notes complexity level and auto-creation of a practice session.

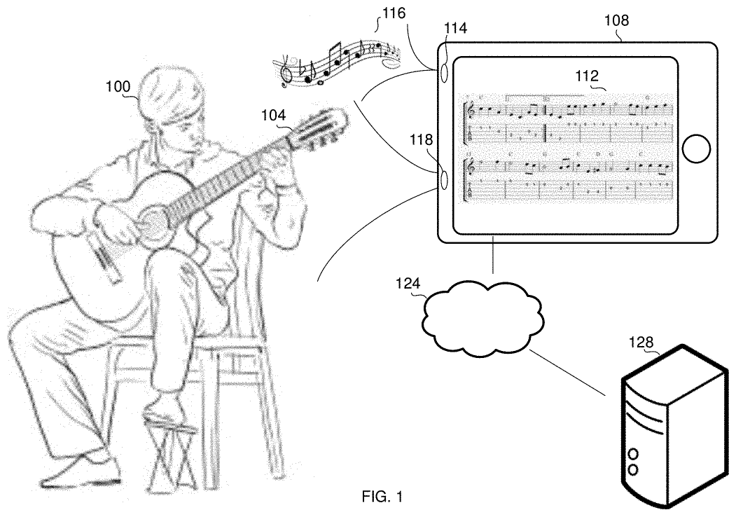

Reference is now made to FIG. 1. A user 100 is learning to play guitar 104. User 100 may activate an application installed on or executed by device 108. Device 108 may be a tablet computer, smart phone, a mobile phone, a desktop computer, a laptop computer, a projection device for projecting the image onto a surface, augmented reality (AR), or the like. User 100 may select a song or another piece to learn, and optionally a difficulty level or player level.

User 100 is then provided with musical instructions such as notes, tabs and/or lyrics 112 of the selected musical pieces. In some embodiments, where BGM is provided as accompaniment, sound 116 containing the BGM for the selected piece is played through one or more speakers of device 108 such as speaker 114, or another device such as earphones, external speaker, or the like. Musical instructions may also pertain to expression and/or tempo including, for example, “accelerando”, “adagio”, “crescendo”, “piano”, “pizzicato”, etc. Optionally, the roles of other users playing in the arrangement of the selected piece may also be played by the selected speaker. In some embodiments, the other users play the roles, while in other embodiments, sound 116 comprises the expected roles of the other users.

The user's playing, as well as the sound 116 and optionally additional sound, such as environmental noises, are captured by one or more microphones of device 108 such as microphone 118 and/or external microphones, to generate processable audio-data for analysis.

In some embodiments, the application may be a client application, communicating with a corresponding server application. In this configuration, device 108 may be in wired or wireless communication with server 128, through channel 124, such as the Internet, intranet, LAN, WAN, 5G, or the like. In such a case, the music offering, and the analysis may be performed by either the client application, the server application, or a combination thereof.

When user 100 has finished playing the piece, user 100 may be presented with the analysis results, comprising for example playing errors, general comments, music type or level change recommendations, generate, select and/or suggest personalized practice sessions, or the like.

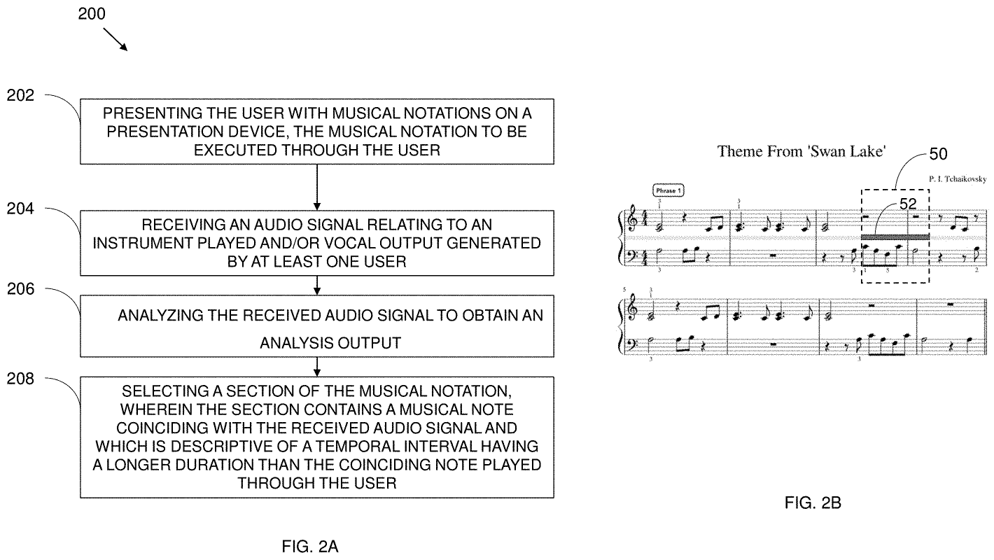

FIG. 2A depicts a flowchart 200 of steps in a method for hands-free following of music being played by the user, including highlighting the area of the notes being/to be played and scrolling the pages, all in a smoothly flowing manner. FIG. 2B schematically shows musical notation containing such highlighted section 50, highlighted by an indicator 52.

The terms “smoothly”, “smoothly flowing” and grammatical variations thereof are used herein to denote a progression of the “cloud indicator”, where movement between adjacent notes is indicated by the gliding movement of the indicator in a contiguous/unbroken manner. This is in contrast to the abrupt or erratic movement of a prior art cursor which “jumps” (disappears and reappears) from one note to the next, even with sequential notes. When a jump is necessary, in the instant system, the cloud indicator, according to one example embodiment, disappears from a first location and appears at a second location, but the indicator encompasses an area of adjacent notes, as opposed to just a single note in the case of a legacy cursor. Highlighting an area/region makes it easier for the user's eye to find the new location.

According to other example embodiments, the movement between the first location and the second location is depicted by an unbroken graphic (sequentially showing origin, path and destination hereafter “relocation graphic”) which leads the user's eye from the first location immediately to the second location, obviating the need to search for the indicator at the new location. Here too, if the user missed the relocation graphic (which may appear on the display only for a very short time), the nature of the highlighted area (larger than an underscore or vertical line) makes it much easier to find (reacquire).

As indicated by block 202, the method may include presenting the user with musical notations on a presentation device, the musical notation to be executed through the user. Based on musical notation presented to the user, he/she may play an instrument and/or sing, resulting in the generation of a user-generated audio signal.

As indicated by block 204, the method may include receiving an audio signal relating to an instrument played and/or vocal output generated by at least one user. The user-generated audio signal may be based on sound captured from an instrument, may be or relate to audio signals of an electronic instrument, and/or may be based on vocal output produced by the user. In some examples, the system generates (e.g., discrete units of) user-generated audio data, based on the received audio signal. The system processes the user-generated audio data.

As indicated by block 206, the method may further include analyzing the received audio signal to obtain an analysis output.

As indicated by block 208, the method may include selecting a section of the musical notation. The section may include a musical note coinciding with the received audio signal. Furthermore, the section may be descriptive of a temporal interval having a longer duration than the coinciding note played through/by the user, such that the temporal interval is included or encompassed, with respect to tempo, in the section. In some other examples, the temporal interval of the section may be shorter than or equal to duration than the coinciding note played through/by the user.

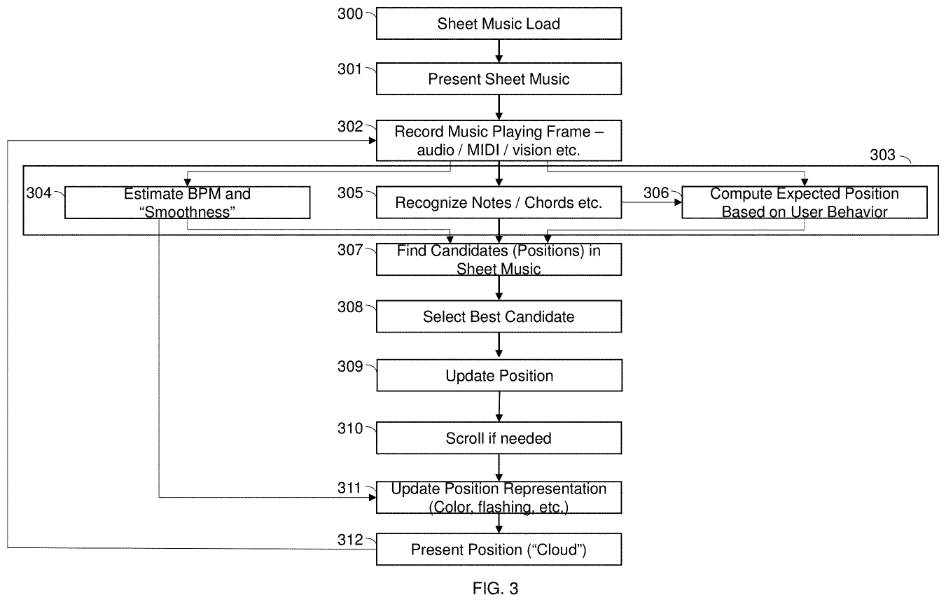

In some embodiments, based on the processing, the system may predict a next note to be played. FIG. 3 details additional steps in the process of predicting the subsequent notes to be played. Briefly, these steps include: estimating the speed the user is playing; estimating the location of the notes being played on the music sheets using note recognition; and estimating the position of the subsequent section based on learned behavior.

In some embodiments, the system may highlight an area that includes the predicted subsequent note that the user will play. For example, when the note playing is sequential, the indicator area may encompass the note currently being played as well as one or more subsequent notes to be played.

FIG. 3 depicts a flowchart of the steps of the method according to an example embodiment.

The method may include, for example, selecting musical notations (block 300).

At step 301 the musical notations that have been selected are displayed on a presentation device. The user starts to play and/or sing resulting in the generating of an audio signal.

At step 302 the device captures (receives, records) the audio signal, e.g., through a microphone, digital MIDI connection, etc. In some examples, an imaging device may be employed to capture visual data descriptive of information about the playing of an instrument by the user and/or a singing performance.

At step 303 an audio-processing unit of the device generates (e.g., discrete units of) user-generated audio data from the received audio signal. The user-generated audio data is stored in a memory. A processor processes the user-generated audio data.

According to an example embodiment, the system starts recording the user's music playing frame by frame. The frame can be of arbitrary size, from one sample to a buffer of samples (the standard implementation in most CODECs today, with or without overlapping of samples). In parallel, the user playing is being recorded (captured)—the capturing can be done in various methods—pure audio, MIDI, vision, or any other method of retrieval of what is being played. The captured frame is the input for the processing modules (at steps 304-306) discussed below. In turn, the processing modules provide the inputs for a decision module (at step 307) that computes the possible currently and/or subsequently to be played positions, in the sheet music.

Step 304-306 may run subsequent to each other, in parallel, or in any order. In some cases, not all of these processes are run.

At step 304 an algorithm calculates a pace of progression of execution of the musical notations relative to the (e.g., discrete units of) user-generated audio data, based on the processing of the user-generated audio data mentioned above. In essence, step 304 estimates or approximates the user's speed of playing (i.e., BPM) or, in other words, the user's rate to perform musical notations presented to him/her. A user's progression or performance score may for example be expressed in terms of notes correctly executed per period of time. The algorithm (presented herein as a module, e.g., a software module) also extrapolates the “smoothness” of the user playing. Smoothness is a measure of how probable it is that the user will keep playing the next notes in a smooth way. This extrapolation can be made based on heuristics or past user playing methods or the way other users played that same piece of music.

At step 305, an algorithm (represented here as a module, such as a software module), identifies a current section of the musical notations which corresponds to the user-generated audio data currently being generated. In this module, position estimation is based on note recognition. This module is based on recognition of the performed input(s), and outputs possible interpretation(s) of what the user played while taking into account what is expected to be played, what was played before, and what the user actually played. This module performs matching of the sequence of last played notes and compares to the expected matches in the current locations and other places around it (the meaning of around it can be defined as a narrow or wide search). The result is possible positions of the next note to be played, possibly with an attached probability.

While the user plays, the sound information may be extracted from the received (e.g., captured and recorded) sound information, such that the component of the user's playing may be recognized, e.g., for the purpose of recognition and comparing with one or more corresponding musical notations.

Non-limiting examples of notations may include any visual expression of music being or to be played such as notes, chords, tabs, rhythm notations, color indications, scores, illustrations, figures of merit (also: scores), text, and/or the like. The notations may be descriptive of note pitch, length, note value, chords, key, tempo, instrumentation, and/or any other relevant music score information. In addition to the recognition results, recognition score may be determined, such as a numerical value or a verbal score, for example recognition OK, no recognition, error, unknown, probabilistic measure, compare to expected note(s), chord(s) or other music expressions instructions, and ignore (for repeated error). In some embodiments, a probabilistic measure, or a comparison to expected note(s) may be output. Segments or sequences in which the recognition is poor may be collected over time and saved for future practice. The term segment or sequence may relate to any issue with the user's performance, including a sequence of notes, tempo, rhythm, technique, notes, chords, transitions, or the like.

At step 306, an algorithm (represented here as a module, such as a software module), estimates the subsequent section of the musical notifications the user will execute, based, at least, on past behavior of the user (e.g., based on the user performance (step 305)). Alternatively, or additionally, the behavior learned by the algorithm (for example, a machine learning algorithm or model) can be general (crowdsourcing/personas) user behaviors. This module learns how the user behaves while playing, such as, when the user keeps on playing the same note, when and how far back s/he goes to repeat the same note or part, and/or how many times the part is repeated. According to embodiments, the results of the recognition module (at step 305) serve as input to this behavior module. Using the inputs from the recognition module, the behavior module predicts what the user will do next, and with what probability.

At step 307, a decision module (e.g., an algorithm/ML model) integrates the outputs of modules (steps/blocks 304, 305, 306) into a decision regarding what are the possible next placement of the “cloud cursor” (highlighting an area including the predicted subsequent notes, as opposed to an accurate cursor of the location of the next note to be played). The module weighs the various inputs and produces a decision about the next position of the center of the “cloud”. For example, whether to continue normal playing progress to the next note in the sheet music or to jump to a new location. The decision is a combination of the three predictors (blocks 304, 305, 406). A decision can for example include a majority decision of the predictors, machine learning decision making, linear prediction, rule-based, etc. The result of executing any of these processes may be a list of candidate positions/regions for the indicator to be displayed, and possibly with associated probability scores. The “probability score” or simply “probability” refers to the statistical likelihood of the prediction to be correct. The candidate position with the highest score may be chosen by the system (e.g., to preload the location or to actually highlight the location/notes/region).

At step 308, a flow module selects, out of the candidate regions/regions, at least one candidate region, based on at least one candidate region selection criterion. The at least one candidate region selection criterion may for example be defined with respect to user experience characteristics, for example, to improve or optimize the user's playing experience. The user's playing experience may be determined based on one or more performance parameter values including, for example, number of errors made by the user, the progress made by the user, rate of completion of a musical piece, level of difficulty of musical piece as compared to the user's playing level and the like. The selection is made based on probability or score and past events. The main emphasis is to keep the smooth flow of playing (assuming the user plays naturally in a smooth way). The intention is not to highlight the exact position but rather a region (“Cloud”), so as to ensure, as much as possible, that there are minimal jumps and changes that are not smooth.

At step 309, the position of the “Cloud” cursor or region is updated. At step 310, based on the position decision, an auto-scroll module is checked to see if playing the next note requires the application to scroll up or down. For example, if the user is playing one of the last lines of the score or the next to be played, the sheet music line is scrolled up. The sheet music can be scrolled down or up by one or more score lines.

At step 311, based on the estimated BPM and smoothness (step 308) and the expected BPM for this sheet music (e.g., included in metadata loaded with selected music at step 302), the representation of the new notation region (“Cloud indication”) can be enhanced, for example, to show blue color when on pace, red when playing too fast, or green when playing too slow, or any other method to highlight the smoothness and pace compared to the expected pace for the selected sheet music.

At step 312, the device indicates, on the presentation device, a section of the musical notations that includes the subsequent section. Presentation of the new location and/or region in a “Cloud” manner is presented to the user (telling the user where to focus their eyes when playing the next notes). The process may then start again from step 302, for example.

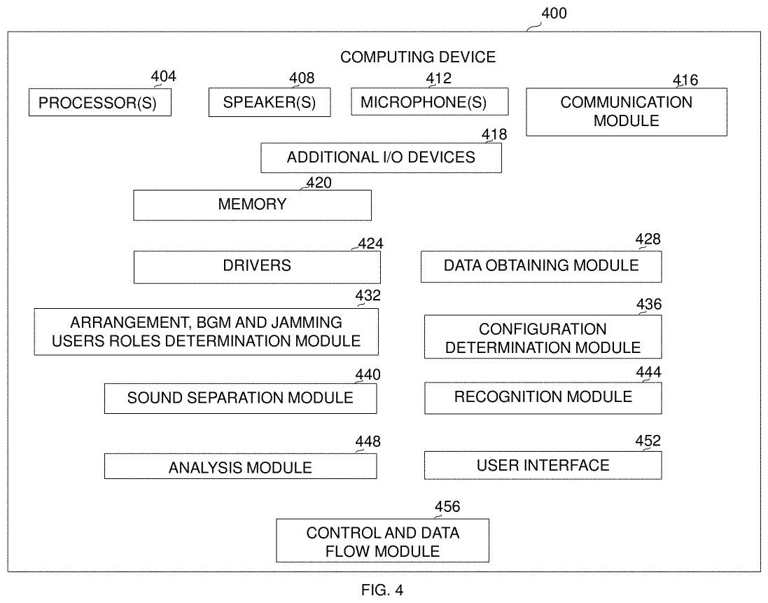

FIG. 4 shows components related to selection and setting of the I/O devices. It will be appreciated that other components may be included in order to provide a full system for teaching a user to play a musical instrument in accordance with the disclosure.

The apparatus may comprise computing device 400 such as tablet or smartphone 108 of FIG. 1. Computing device 400 may comprise one or more processors 404. Any of processors 404 may be a Central Processing Unit (CPU), a microprocessor, an electronic circuit, an Integrated Circuit (IC) or the like. Processors 404 may be utilized to perform computations required by computing device 400 or any of its subcomponents, for example steps in the methods of FIG. 2, FIG. 3 or FIG. 4 above.

Computing device 400 may comprise one or more speakers 408. In some embodiments, one or more of speakers 408 may be external to computing device 400.

Computing device 400 may comprise one or more microphones 412. In some embodiments, one or more of microphones 412 may be external to computing device 400.

Computing device 400 may include communication module 416, for communicating with a server such as server 128 of FIG. 1, with databases storing music pieces and arrangements, or the like.

Computing device 400 may comprise additional I/O devices and/or sensors 418 including, for example, inertial and/or non-inertial sensors such as cameras, linear acceleration sensors, angular acceleration sensors, gyroscopes, satellite-based navigation systems (e.g., the US-based Global Positioning System). Microphones 412 and/or additional I/O devices and/or sensors 418 may be employed, for example, to identify the position of the device, the distance from the user and from the musical instrument, the type of music instrument being played by the player or players, and/or the like. In some embodiments, recognition may be performed by fusing visual and audio sources. For example, a back camera can identify that the back cover covers a microphone.

Computing device 400 may comprise one or more storage devices 420 for storing executable components, and which may also contain data during execution of one or more components. Storage device 420 may be persistent or volatile. For example, storage device 420 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 420 may store data structures and program code operative to cause any of processors 404 to perform acts associated with any of the steps disclosed herein.

It will be appreciated that processor 404 and/or a processor of server 128 is operable to execute methods, processes and/or operations described herein. For instance, processor 404 may execute program code instructions resulting in the implementation of, for example, one or more device drivers 424, a data obtaining module 428, an arrangement, BGM and Jamming Roles Determination Module 432, a Device Configuration Determination Module 436, a Sound Separation Module 440, a Recognition Module 444, an Analysis Module 448, a user interface application module 452, a control and data flow module 456 and/or result in the implementation of a method for providing a music playing and/or learning session, including, for example, selecting and setting I/O devices for improving the recognition quality and enhancing the user experience.

### ADDITIONAL EXAMPLES

Example 1 pertains to a method for indicating musical notations for at least one user to execute, including: presenting the at least one user with musical notations on a presentation device, the musical notation to be executed through the user; receiving an audio signal relating to an instrument played and/or vocal output generated by the at least one user; analyzing the received audio signal to obtain an analysis output; and selecting a section of the musical notation, wherein the section contains a musical note coinciding with the received audio signal and which is descriptive of a temporal interval having a longer duration than the coinciding note played through the user.

In Example 2, the subject matter of example 1 may optionally further include providing the user with an indication about the selected section of the musical notation.

In Example 3, the subject matter of examples 1 or 2 may optionally further include, predicting, based on the analysis output, a subsequent section of the musical notations that will coincide with the user-generated audio signal the user will subsequently generate.

In example 4, the subject matter of any one or more of the preceding examples may optionally include generating (e.g., discrete units of) user-generated audio data, based on the received audio signal; processing the user-generated audio data.

In example 5, the subject matter of example 4 may optionally include, wherein the step of predicting is based on at least one of: (a) determining, based on the processing of the user-generated audio data, a pace of progression of execution of the musical notations relative to the (e.g., discrete units of) user-generated audio data, (b) identifying, based on the processing of the user-generated audio data, a current section of the musical notations which corresponds to the user-generated audio data currently generated, and (c) estimating said subsequent section of the musical notifications the user will execute, based at least on past behavior of the user.

Example 6 pertains to a system configured to provide a music learning session, comprising: a memory for storing data and executable instructions; and a processor that is configured to execute the execution instructions to result in the following: presenting the user with musical notations on a presentation device, the musical notation to be executed through the user for generating user-generated sound; capturing an audio signal relating to an instrument and/or vocal output generated by at least one user; predicting a subsequent section of the musical notations that will coincide with the user-generated sound the user will subsequently generate; and indicating, on the presentation device, a section of the musical notations that includes the subsequent section.

In example 7, the subject matter of example 6 may optionally include, wherein the processor is further configured to indicate a present section of the musical notations that coincides with the user-generated sound the user is currently generating.

In example 8, the subject matter of example 7 may optionally include, wherein the processor is further configured to indicate a path between said present section and said subsequent section.

In example 9, the subject matter of example 6 may optionally include, wherein the processor is configured not to indicate a present section of the musical notations that coincides with the user-generated sound the user is currently generating.

Example 10 pertains to a method for indicating musical notations for at least one user to execute, including: presenting the at least one user with musical notations on a presentation device, the musical notation to be executed through the user; receiving an audio signal relating to an instrument played and/or vocal output generated by the at least one user; analyzing the received audio signal to obtain an analysis output; predicting, based on the analysis output, a subsequent section of the musical notations that will coincide with the user-generated audio signal the user will subsequently generate; selecting only the subsequent section of the musical notation, wherein the section contains a musical note coinciding with the user-generated audio signal the user will subsequently generate.

In example 11, the subject matter of example 10 may optionally include, providing the user with an indication only about the selected section of the musical notation.

The various features and steps discussed above, as well as other known equivalents for each such feature or step, can be mixed and matched by one of ordinary skills in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Any digital computer system, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein. The term “non-transitory” is used to exclude transitory, propagating signals, but to otherwise include any volatile or non-volatile computer memory technology suitable to the application.

Additionally, or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms ‘about’ and/or ‘close’ with respect to a magnitude or a numerical value may imply to be within an inclusive range of −10% to +10% of the respective magnitude or value.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not to be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

As used herein the term “configuring” and/or ‘adapting’ for an objective, or a variation thereof, implies using materials and/or components in a manner designed for and/or implemented and/or operable or operative to achieve the objective.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A,B,C, or any combination of the aforesaid” should be interpreted as meaning all of the following: (i) A or B or C or any combination of A, B, and C, (ii) at least one of A, B, and C; and (iii) A, and/or B and/or C. This concept is illustrated for three elements (i.e., A,B,C), but extends to fewer and greater numbers of elements (e.g., A, B, C, D, etc.).

It is noted that the terms “operable to” or “operative to” can encompass the meaning of the term “adapted or configured to”. In other words, a machine “operable to” or “operative to” perform a task can in some embodiments, embrace a mere capability (e.g., “adapted”) to perform the function and, in some other embodiments, a machine that is actually made (e.g., “configured”) to perform the function.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 4, from 1 to 4, from 1 to 5, from 2 to 4, from 2 to 6, from 4 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It should be appreciated that a combination of features disclosed in different embodiments are also included within the scope of the present inventions.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system configured to provide a music learning session, comprising:
a memory for storing data and executable instructions; and
a processor that is configured to execute the execution instructions to result in the following:
presenting the at least one user with musical notations on a presentation device, the musical notation to be executed through the user,
receiving an audio signal relating to an instrument played and/or vocal output generated by the at least one user,
analyzing the received audio signal to obtain an analysis output, and
selecting a section of the musical notation, wherein the section contains a musical note coinciding with the received audio signal and which is descriptive of a temporal interval having a longer duration than the coinciding note played through the user.

2. The system of claim 1, further configured to provide the user with one or more indicators about the selected section of the musical notation.

3. The system of claim 1, further configured to:
predict, based on the analysis output, a subsequent section of the musical notations that will coincide with the user-generated audio signal the user will subsequently generate.

4. The system of claim 1, further configured to:
generate user-generated audio data, based on the received audio signal, and
processing the user-generated audio data.

5. The system of claim 1, further configured to present a first indicator highlighting a selected first section of longer duration, and a second indicator highlighting a selected second section of shorter duration than the first indicator.

6. The system of claim 1, further configured to present a first indicator highlighting a certain staff, and a second indicator highlighting a section that is part of the staff highlighted by the first indicator.

7. The system of claim 1, configured to present an indicator of a musical notation section containing one or more notes played by the user a second time differently to correct for errors than a musical notation section displayed to the user for playing in the chronological order.

8. The system of claim 1, wherein a first indicator pertains to notes to be played and/or being played by the user's right hand, and a second indicator pertains to notes being and/played by the user's left hand.

9. The system of claim 1, wherein a first indicator and a second indicator are presented in positional alignment relative to each other with respect to musical notations to be played.

10. The system of claim 1, configured to present an indicator to highlight a selected section of musical notation, wherein the indicator represents a constant duration.

11. The system of claim 1, configured to present an indicator to highlight a selected section of musical notation, wherein a duration represented by the indicator is an adaptive duration.

12. The system of claim 11, wherein the duration represented by the indicator is adapted based on characteristics of audio data generated by the user.

13. The system of claim 11, wherein the duration represented by the indicator is adapted based on one or more characteristics of a musical piece displayed to the user for playing thereby.

14. The system of claim 11, wherein a time interval of the indicator may be longer for a musical piece that is to be played at a first, greater speed or tempo, than the time interval of the indicator displayed for a musical piece to be played at a second, comparatively slower tempo.

15. The system of claim 11, wherein a time interval of an indicator may be shorter for a musical piece that is to be played at a first, greater speed or tempo, than the time interval of an indicator displayed for a musical piece to be played at a second, comparatively slower tempo.

16. A method for indicating musical notations for at least one user to execute, comprising:
presenting the at least one user with musical notations on a presentation device, the musical notation to be executed through the user;
receiving an audio signal relating to an instrument played and/or vocal output generated by the at least one user;
analyzing the received audio signal to obtain an analysis output; and
selecting a section of the musical notation, wherein the section contains a musical note coinciding with the received audio signal and which is descriptive of a temporal interval having a longer duration than the coinciding note played through the user.

17. The method of claim 16, further comprising providing the user with an indication about the selected section of the musical notation.

18. The method of claim 16, further comprising:
predicting, based on the analysis output, a subsequent section of the musical notations that will coincide with the user-generated audio signal the user will subsequently generate.

19. The method of claim 16, further comprising:
generating user-generated audio data, based on the received audio signal; and
processing the user-generated audio data.

20. The method of claim 18, wherein said predicting is based on at least one of:
a. determining, based on the processing of the user-generated audio data, a pace of progression of execution of the musical notations relative to the user-generated audio data,
b. identifying, based on the processing of the user-generated audio data, a current section of the musical notations which corresponds to the user-generated audio data currently generated, and
c. estimating said subsequent section of the musical notifications the user will execute, based at least on past behavior of the user.
